(19) United States
(12) Patent Application Publication
(10) Pub. No.: US 2013/0215059 A1
(43) Pub. Date: Aug. 22, 2013

(54) APPARATUS AND METHOD FOR CONTROLLING AN OBJECT IN AN ELECTRONIC DEVICE WITH TOUCH SCREEN

(71) Applicant: Samsung Electronics Co., Ltd., (US)

(72) Inventors: Hyo-Jin LIM, Gyeonggi-do (KR); Jae-Wook SHIN, Gyeonggi-do (KR)

(73) Assignee: SAMSUNG ELECTRONICS CO., LTD., Gyeonggi-do (KR)

(21) Appl. No.: 13/771,726

(22) Filed: Feb. 20, 2013

(30) Foreign Application Priority Data
Feb. 21, 2012 (KR) 10-2012-0017421

(51) Int. Cl. G06F 3/01

(52) U.S. Cl. CPC G06F 3/01
USPC 345/173

(57) ABSTRACT

An apparatus and method control an object in an electronic device with a touch screen. The method edits an object and includes selecting at least one of a plurality of objects for editing based on touch information and, when an editing event occurs, performing the editing for the selected at least one of the objects.

### CLAIM OF PRIORITY

This application claims, pursuant to 35 U.S.C. §119(a), priority to and the benefit of the earlier filing date of a Korean Patent Application filed in the Korean Intellectual Property Office on Feb. 21, 2012 and assigned Serial No. 10-2012-0017421, the contents of which are herein incorporated by reference.

### BACKGROUND OF THE INVENTION

1. Field of the Invention

The present invention relates to an electronic device with a touch screen. More particularly, the present invention relates to an apparatus and method for controlling an object in an electronic device with a touch screen.

2. Description of the Related Art

Portable electronic devices have become necessities of modern people due to the easiness of carrying such devices. Portable electronic devices are evolving into multimedia devices providing various services such as a voice and video call function, an information input output function, and data storage.

As a portable electronic device provides a multimedia service, the amount of information processed and the amount of information to display are increased. Accordingly, there is increased concern about the ability of a portable electronic device with a touch screen being capable of improving space utilization and increasing a size of a display unit.

The touch screen is an input/output device for performing the input and display of information in one screen. Therefore, the portable electronic device can replace a separate input device such as a keypad with the touch screen, thereby being capable of increasing a display area.

As described above, a portable electronic device can provide various multimedia services to users through a larger picture using a touch screen. However, because the portable electronic device with the touch screen is different in its manipulation methods from an electronic device with a separate input device such as a keypad, such a portable electronic device requires a separate user interface using a touch screen.

### SUMMARY OF THE INVENTION

An aspect of the present invention is to substantially solve at least the above problems and/or disadvantages and to provide at least the advantages below. Accordingly, one aspect of the present invention is to provide an apparatus and method for deleting an object in an electronic device.

Another aspect of the present invention is to provide an apparatus and method for changing a position of an object in an electronic device.

A further aspect of the present invention is to provide an apparatus and method for editing a plurality of objects in an electronic device with a touch screen.

Yet another aspect of the present invention is to provide an apparatus and method for editing a plurality of objects by one event occurrence in an electronic device with a touch screen.

Still another aspect of the present invention is to provide an apparatus and method for reducing a processing time required to delete a plurality of objects in an electronic device with a touch screen.

Still another aspect of the present invention is to provide an apparatus and method for reducing a processing time required to change positions of a plurality of objects in an electronic device with a touch screen.

Still another aspect of the present invention is to provide an apparatus and method for deleting a plurality of objects by one event occurrence in an electronic device with a touch screen.

Still another aspect of the present invention is to provide an apparatus and method for changing positions of a plurality of objects by one event occurrence in an electronic device with a touch screen.

The above aspects are achieved by providing an apparatus and method for controlling an object in an electronic device with a touch screen.

According to one aspect of the present invention, a method for changing a position of an object in a device with a touch screen is provided. The method includes selecting a plurality of objects to change positions and, if a position change event occurs, changing the positions of the plurality of objects.

According to another aspect of the present invention, an apparatus for changing a position of an object in a device with a touch screen is provided. The apparatus uses a touch screen for displaying at least one object and a controller for selecting a plurality of objects to change positions and, when a position change event occurs, changing positions of the plurality of objects.

According to a further aspect of the present invention, a method for deleting an object in a device with a touch screen is provided. The method includes selecting a plurality of objects to be deleted and, when a deletion event occurs, deleting the plurality of objects.

According to still another aspect of the present invention, an apparatus for deleting an object in a device with a touch screen is provided. The apparatus uses a touch screen for displaying at least one object and a controller for selecting a plurality of objects to be deleted and, when a deletion event occurs, deleting the plurality of objects.

According to yet another aspect of the present invention, a method for editing an object in an electronic device with a touch screen is provided. The method includes selecting a plurality of objects for editing using touch information and, when an editing event occurs, performing editing for the selected plurality of objects.

According to yet another aspect of the present invention, an electronic device includes a touch screen, and a controller for selecting a plurality of objects for editing using touch information sensed through the touch screen and, when an editing event occurs, performing editing for the selected plurality of objects.

### BRIEF DESCRIPTION OF THE DRAWINGS

The above and other objects, features and advantages of the present invention will become more apparent from the following detailed description when taken in conjunction with the accompanying drawings in which:

FIG. 1 is a flowchart illustrating a procedure for deleting an object using a multi-touch in an electronic device according to an exemplary embodiment of the present invention;

FIGS. 2A, 2B, 2C and 2D are diagrams illustrating a screen configuration for deleting an object in the electronic device according to the exemplary embodiment of the present invention;

FIG. 3 is a flowchart illustrating a procedure for selecting an object to be deleted using touch information in the electronic device according to a first exemplary embodiment of the present invention;

FIG. 4 is a flowchart illustrating a procedure for selecting an object to be deleted using touch information in the electronic device according to a second exemplary embodiment of the present invention;

FIG. 5 is a flowchart illustrating a procedure for selecting an object to be deleted using touch information in the electronic device according to a third exemplary embodiment of the present invention;

FIG. 6 is a flowchart illustrating a procedure for selecting an object to be deleted using touch information in the electronic device according to a fourth exemplary embodiment of the present invention;

FIG. 7 is a flowchart illustrating a procedure for shifting an object using a multi-touch in the electronic device according to the exemplary embodiment of the present invention;

FIGS. 8A, 8B, 8C and 8D are diagrams illustrating a screen configuration for shifting an object in the electronic device according to the exemplary embodiment of the present invention;

FIG. 9 is a flowchart illustrating a procedure for selecting an object to be shifted using touch information in the electronic device according to the first exemplary embodiment of the present invention;

FIG. 10 is a flowchart illustrating a procedure for selecting an object to be shifted using touch information in the electronic device according to the second exemplary embodiment of the present invention;

FIG. 11 is a flowchart illustrating a procedure for selecting an object to be shifted using touch information in the electronic device according to the third exemplary embodiment of the present invention;

FIGS. 12A, 12B, 12C, 12D, 12E and 12F are diagrams illustrating a screen configuration for shifting a selected object using touch information in the electronic device according to the third exemplary embodiment of the present invention;

FIG. 13 is a flowchart illustrating a procedure for selecting an object to be shifted using touch information in the electronic device according to the fourth exemplary embodiment of the present invention;

FIGS. 14A, 14B, 14C, 14D, 14E and 14F are diagrams illustrating a screen configuration for shifting a selected object using touch information in the electronic device according to the fourth exemplary embodiment of the present invention; and

FIG. 15 is a block diagram illustrating a construction of the electronic device according to the present invention.

### DETAILED DESCRIPTION OF THE INVENTION

Exemplary embodiments of the present invention will be described herein below with reference to the accompanying drawings. In the following description, well-known functions or constructions are not described in detail since they would obscure the invention in unnecessary detail. In addition, terms described below, which are defined with reference to functions in the present invention, can be different depending on a user and operator's intention or practice. Therefore, the terms should be understood on the basis of the disclosure throughout this specification.

The present invention may, however, be embodied in many different forms and should not be construed as limited to the exemplary embodiments set forth herein. The principles and features of this invention may be employed in varied and numerous embodiments without departing from the scope of the invention.

The same reference numbers are used throughout the drawings to refer to the same or like parts. Furthermore, although the drawings represent exemplary embodiments of the invention, the drawings are not necessarily to scale and certain features may be exaggerated or omitted in order to more clearly illustrate and explain the present invention.

Among the terms set forth herein, a terminal refers to any kind of device capable of processing data which is transmitted or received to or from any external entity. The terminal may display icons or menus on a screen to which stored data and various executable functions are assigned or mapped. The terminal may include a computer, a notebook, a tablet PC, a mobile device, and the like.

Among the terms set forth herein, a screen refers to a display or other output devices which visually display information to the user, and which optionally are capable of receiving and electronically processing tactile inputs from a user using a stylo, a finger of the user, or other techniques for conveying a user selection from the user to the output devices.

Among the terms set forth herein, an icon refers to a graphical element such as a figure or a symbol displayed on the screen of the device such that a user can easily select a desired function or data. In particular, each icon has a mapping relation with any function being executable in the device or with any data stored in the device and is used for processing functions or selecting data in the device. When a user selects one of the displayed icons, the device identifies a particular function or data associated with the selected icon. Then the device executes the identified function or displays the identified data.

Among the terms set forth herein, data refers to any kind of information processed by the device, including text and/or images received from any external entities, messages transmitted or received, and information created when a specific function is executed by the device.

An apparatus and method incorporating and implementing technology for editing a plurality of objects in an electronic device with a touch screen according to the present invention is described below. Here, the object includes an application icon, a widget, a thumbnail image and the like. Also, editing includes, but not limited to, shifting and/or deleting such objects.

In the following description, the electronic device includes a mobile communication terminal with a touch screen, a Portable Digital Assistant (PDA), a laptop computer, a smart phone, a netbook, a Mobile Internet Device (MID), a Ultra Mobile Personal Computer (UMPC), a tablet PC, a navigator, an MPEG Audio Layer-3 (MP3) player and/or device, and the like.

In the following description, “touch” represents a touch down state in which a user touches the touch screen, and “release” represents a touch up state in which the user releases the touch of the touch screen. Also, “tap” represents a series of operations that, after touching a touch screen, the user successively releases the touch, and a “multi-touch” represents a touch down state in which a user touches the touch screen in at least two different locations simultaneously.

In the following description, the electronic device performs editing for deletion or a position change of a plurality of objects.

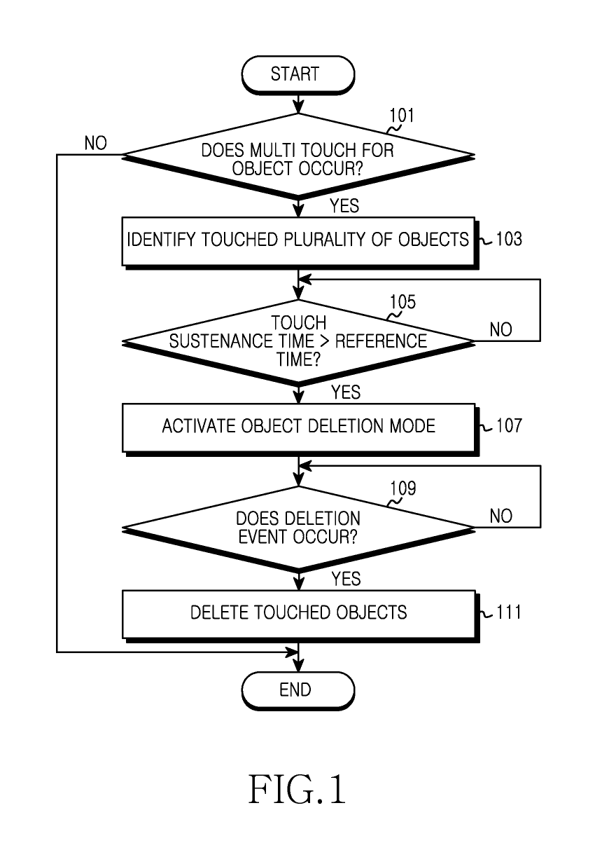

FIG. 1 illustrates a procedure for deleting an object using a multi-touch in the electronic device according to an exemplary embodiment of the present invention.

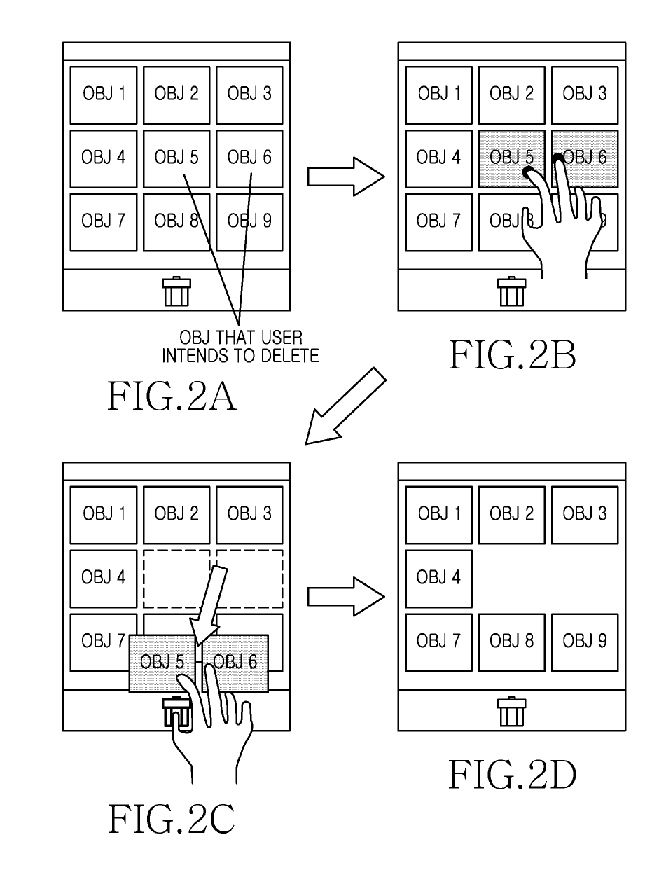

Referring to FIG. 1, the electronic device proceeds to step 101 and identifies if a multi-touch of objects is sensed. For example, when a user intends to delete objects, for example the objects represented by the labels OBJ 5 and OBJ 6 illustrated in FIG. 2A, the electronic device identifies if a multi-touch of OBJ 5 and OBJ 6 is sensed as illustrated in FIG. 2B. As used herein and in the drawings, the term “OBJ” refers to an object.

If it is identified in step 101 that the multi-touch of the objects is not sensed, the electronic device recognizes that a deletion event for the objects has not occurred. Therefore, the electronic device terminates the method of the present invention.

On the other hand, when it is identified in step 101 that the multi-touch of the objects is sensed, the electronic device proceeds to step 103 and identifies the objects selected through the multi-touch.

After that, the electronic device proceeds to step 105 and identifies if a touch sustenance or duration time of the multi-touch sensed in step 101 is longer than a predetermined reference time, which may be measured, for example, in milliseconds or multiple seconds. As used herein, the term “sustenance” is defined as sustaining, continuing, or maintaining a condition or state, such as maintaining a touch of a finger or stylus on a touch screen for a duration of time.

When it is identified in step 105 that the touch sustenance time of the multi-touch is shorter than or is equal to the reference time, the electronic device recognizes that the deletion event for the objects has not occurred. If the multi-touch is released, the electronic device loops back and proceeds to step 105 and again identifies if the touch sustenance time of the multi-touch is longer than the reference time. Alternatively, in step 105, if the multi-touch is released before the reference time has completed, the electronic device terminates the method of the present invention.

On the other hand, when it is identified in step 105 that the touch sustenance time of the multi-touch is longer than the reference time, the electronic device activates an object deletion mode in step 107. For example, when the object deletion mode is activated, the electronic device displays the objects on a screen such that the objects appear to vibrate or shake at regular or irregular intervals. In another example, when the object deletion mode is activated, the electronic device may display a background shade of the screen darker than before activating the object deletion mode. In a further example, when the object deletion mode is activated, the electronic device may display a pop-up window including object deletion mode activation information.

Next, the electronic device proceeds to step 109 and identifies if the deletion event has occurred. For instance, the electronic device identifies if the objects selected through the multi-touch are dragged to a deletion area as illustrated in FIG. 2C. In another example, when the object deletion mode is activated, the electronic device can display deletion icons for the objects selected through the multi-touch; for example, the deletion icons may be displayed substantially adjacent to each corresponding object to be deleted. In this case, the electronic device identifies if there is a selection of the deletion icons of the objects selected through the multi-touch. Here, the deletion area represents a specific area that is set for an object deletion instruction as illustrated in FIGS. 2A-2D.

When it is identified in step 109 that the deletion event has occurred, the electronic device proceeds to step 111 and deletes the plurality of objects identified in step 103. For instance, when OBJ 5 and OBJ 6, selected through a multi-touch in FIG. 2B, are dragged to the deletion area as illustrated in FIG. 2C, the electronic device deletes OBJ 5 and OBJ 6, and removes their corresponding icons from the screen as illustrated in FIG. 2D.

After step 111, the electronic device terminates the method of the present invention.

In the aforementioned exemplary embodiment, the electronic device deletes objects selected through a multi-touch. In the exemplary embodiment, the electronic device may delete an object selected through a single touch using the same method as that of FIG. 1.

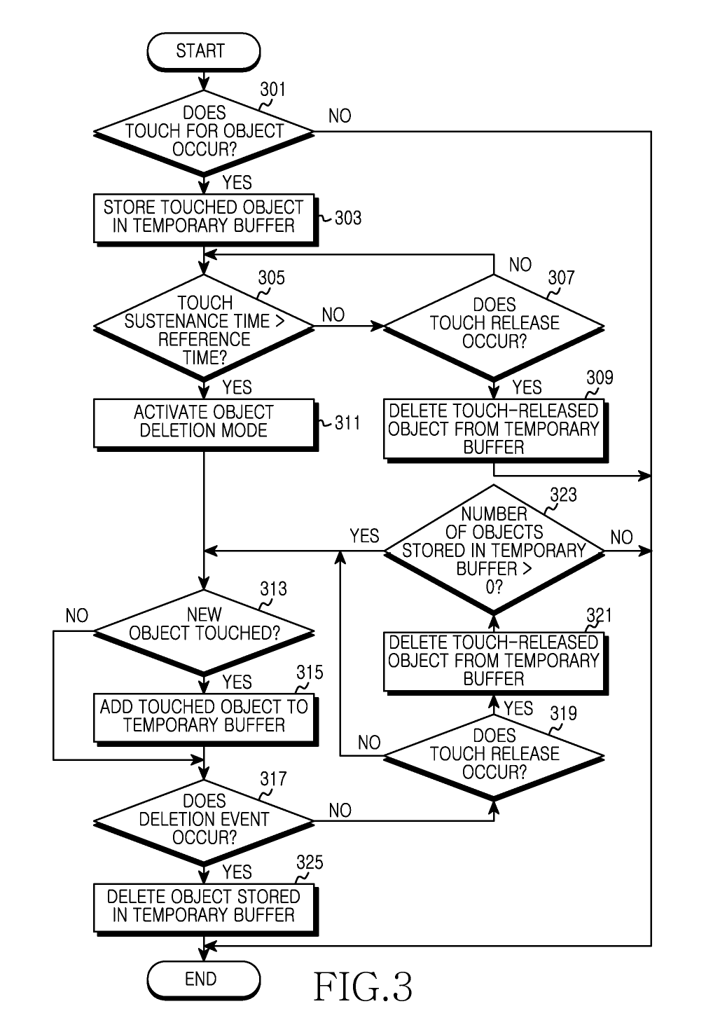

As described above, an electronic device deletes a plurality of objects selected through a multi-touch by a single deletion event. In the exemplary embodiment, after activating an object deletion mode as illustrated in FIG. 3, the electronic device may additionally select an object to be deleted.

FIG. 3 illustrates a procedure for selecting an object to be deleted using touch information in an electronic device according to a first exemplary embodiment of the present invention.

Referring to FIG. 3, in step 301, the electronic device identifies if a touch of an object is sensed.

If it is identified in step 301 that the touch of the object is not sensed, the electronic device recognizes that a deletion event for the object has not occurred. Therefore, the electronic device terminates the method of the present invention.

On the other hand, when it is identified in step 301 that the touch of the object is sensed, the electronic device proceeds to step 303 and stores the touched object in a temporary buffer. Here, the temporary buffer includes an object selected by a user for deletion.

After that, the electronic device proceeds to step 305 and identifies if a sustenance time of the touch sensed in step 301 is longer than a reference time. If it is identified in step 305 that the sustenance time of the touch is shorter than or is equal to the reference time, the electronic device proceeds to step 307 and identifies if the touch sensed in step 301 is released.

If it is identified in step 307 that the touch sensed in step 301 is not released, the electronic device returns to step 305 and again identifies if a sustenance time of the touch sensed in step 301 is longer than the reference time.

However, when it is identified in step 307 that the touch sensed in step 301 is released, the electronic device recognizes that the deletion event for the object has not occurred. Accordingly, the electronic device proceeds to step 309 and deletes object information stored in the temporary buffer. After that, the electronic device terminates the method of the present invention.

Referring back to step 305, when it is identified in step 305 that the sustenance time of the touch is longer than the reference time, the electronic device proceeds to step 311 and activates an object deletion mode. For example, when the object deletion mode is activated, the electronic device displays objects on a screen such that the objects are vibrated, for example, at regular or irregular intervals. In another example, when the object deletion mode is activated, the electronic device may display a background shade of the screen darker before activating the object deletion mode. In a further example, when the object deletion mode is activated, the electronic device may display a pop-up window including object deletion mode activation information. In the exemplary embodiment, the electronic device selects and marks the object included in the temporary buffer such that the object included in the temporary buffer is distinguished from other objects not included in the temporary buffer.

Next, the electronic device proceeds to step 313 and identifies if a touch of a new object is sensed.

When it is identified in step 313 that the touch of the new object is not sensed, the electronic device jumps to step 317 and identifies if the deletion event has occurred. For example, the electronic device identifies whether at least one touched object is dragged to the deletion area. That is, the electronic device identifies whether the at least one object stored in the temporary buffer is dragged to the deletion area.

On the other hand, referring back to step 313, when it is identified in step 313 that the touch of the new object is sensed, the electronic device proceeds to step 315 and adds the newly touched object to the temporary buffer.

Next, the electronic device proceeds to step 317 and identifies if the deletion event has occurred. For instance, the electronic device identifies if at least one touched object is dragged to the deletion area. That is, the electronic device identifies if the at least one object stored in the temporary buffer is dragged to the deletion area.

When it is identified in step 317 that the deletion event has not occurred, the electronic device proceeds to step 319 and identifies if a touch release for the object is sensed.

When it is identified in step 319 that no touch release of an object has occurred, the electronic device returns to step 313 and again identifies if a touch of a new object is sensed.

However, when it is identified in step 319 that a touch release of an object has occurred, the electronic device proceeds to step 321 and deletes the touch-released object from the temporary buffer.

Next, the electronic device proceeds to step 323 and identifies if the number of objects stored in the temporary buffer is greater than zero.

If it is identified in step 323 that the number of objects stored in the temporary buffer is equal to zero, the electronic device recognizes that there is no object to be deleted. Therefore, the electronic device terminates the method of the present invention.

However, when it is identified in step 323 that the number of objects stored in the temporary buffer is greater than zero, the electronic device recognizes that there is an object to be deleted. Accordingly, the electronic device returns to step 313 and again identifies whether a touch of a new object is sensed.

Referring back to step 317, when the deletion event has occurred in step 317, the electronic device proceeds to step 325 and deletes the objects stored in the temporary buffer. For instance, when the touched objects OBJ 5 and OBJ 6 are dragged to the deletion area as illustrated in FIG. 2C, the electronic device deletes OBJ 5 and OBJ 6 as illustrated in FIG. 2D.

Next, the electronic device terminates the method of the present invention.

In the aforementioned exemplary embodiment, after activating an object deletion mode, an electronic device changes a stored list of objects flagged in memory to be deleted; for example, by updating such a stored list to remove, for example, OBJ 5 and OBJ 6 which have been deleted.

In another exemplary embodiment, even before activating an object deletion mode, an electronic device can change a list of objects to be deleted. In this case, a touch sustenance time for determining object deletion mode activation in the electronic device represents a time measured starting from a touch time sensed in step 301. For example, when OBJ 5 and OBJ 6 are touched by a user in step 301, although the touch of any one of OBJ 5 and OBJ 6 is released, the electronic device identifies if an object deletion mode is activated using a touch sustenance time starting from the touch time sensed in step 301. For another example, when OBJ 6 is additionally touched by the user after OBJ 5 is touched in step 301, although the touch of OBJ 5 is released, the electronic device may identify if an object deletion mode is activated using the touch sustenance time starting from the touch time sensed in step 301.

In the aforementioned exemplary embodiment, an electronic device recognizes objects that are touched by a user of the electronic device, as objects to be deleted.

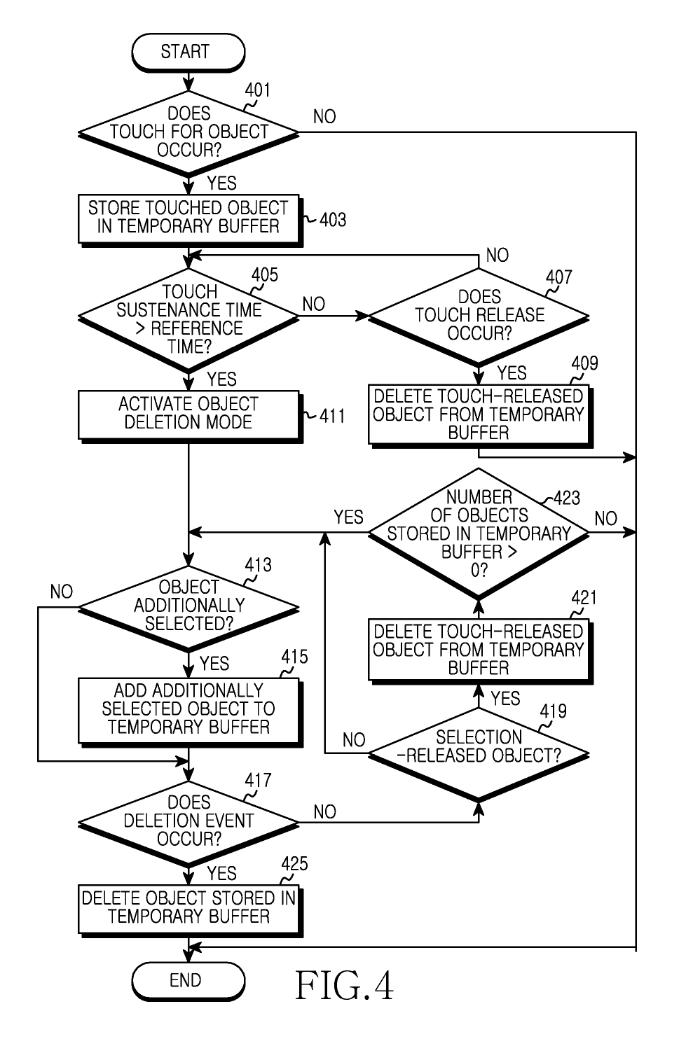

In another exemplary embodiment, when an object deletion mode is activated, an electronic device may select an object to be deleted using tap information as illustrated in FIG. 4 below.

FIG. 4 illustrates a procedure for selecting an object to be deleted using touch information in an electronic device according to a second exemplary embodiment of the present invention.

Referring to FIG. 4, in step 401, the electronic device identifies if a touch of an object is sensed.

If it is identified in step 401 that the touch of the object is not sensed, the electronic device recognizes that a deletion event for the object has not occurred. Therefore, the electronic device terminates the method of the present invention.

On the other hand, when it is identified in step 401 that the touch of the object is sensed, the electronic device proceeds to step 403 and stores the touch-sensed object in a temporary buffer. Here, the temporary buffer includes an object selected by a user for deletion.

After that, the electronic device proceeds to step 405 and identifies if a sustenance time of the touch sensed in step 401 is longer than a reference time.

When it is identified in step 405 that the sustenance time of the touch is shorter than or is equal to the reference time, the electronic device proceeds to step 407 and identifies if the touch of the object touched in step 401 is released.

If it is identified in step 407 that the touch of the object is not released, the electronic device returns to step 405 and again identifies if a sustenance time of the touch sensed in step 401 is longer than the reference time.

However, when it is identified in step 407 that the touch of the object is released, the electronic device recognizes that the deletion event for the object has not occurred. Accordingly, the electronic device proceeds to step 409 and deletes object information stored in the temporary buffer. After that, the electronic device terminates the method of the present invention.

Referring back to step 405, if it is identified in step 405 that the sustenance time of the touch is longer than the reference time, the electronic device proceeds to step 411 and activates an object deletion mode. For instance, when the object deletion mode is activated, the electronic device displays objects on a screen such that the objects are vibrated, for example, at regular or irregular intervals. In another example, when the object deletion mode is activated, the electronic device may display a background shade of the screen darker before activating the object deletion mode. In a further example, when the object deletion mode is activated, the electronic device may display a pop-up window including object deletion mode activation information. In the exemplary embodiment, the electronic device selects and marks the object included in the temporary buffer such that the object included in the temporary buffer is distinguished from other objects not included in the temporary buffer.

Next, the electronic device proceeds to step 413 and identifies if a tap of an object not stored in the temporary buffer is sensed. That is, the electronic device identifies if a tap of an object not selected as an object to be deleted is sensed.

If it is identified in step 413 that the tap of the object not stored in the temporary buffer is not sensed, the electronic device jumps to step 417 and identifies whether the deletion event has occurred. For instance, the electronic device identifies if a drag of an object to a deletion area is sensed.

On the other hand, referring back to step 413, if it is identified in step 413 that the tap of the object not stored in the temporary buffer is sensed, the electronic device proceeds to step 415 and adds the tapped object to the temporary buffer.

Next, the electronic device proceeds to step 417 and identifies if the deletion event has occurred. For example, the electronic device identifies if a drag to the deletion area is sensed.

If it is identified in step 417 that the deletion event has not occurred, the electronic device proceeds to step 419 and identifies if a selection-released object exists. For example, the electronic device identifies if a tap of the object stored in the temporary buffer is sensed. That is, the electronic device identifies if a tap of an object selected as the object to be deleted is sensed.

If it is identified in step 419 that no tap of the object stored in the temporary buffer has been sensed, the electronic device recognizes that there is no selection-released object. In this case, the electronic device returns to step 413 and again identifies if a tap of the object not stored in the temporary buffer is sensed.

However, when it is identified in step 419 that the tap of the object stored in the temporary buffer is sensed, the electronic device recognizes that there is a selection-released object. In this case, the electronic device proceeds to step 421 and deletes the touch-released object from the temporary buffer.

Next, the electronic device proceeds to step 423 and identifies if the number of objects stored in the temporary buffer is greater than zero.

If it is identified in step 423 that the number of objects stored in the temporary buffer is equal to zero, the electronic device recognizes that there is no object to be deleted. Therefore, the electronic device terminates the method of the present invention.

However, if it is identified in step 423 that the number of objects stored in the temporary buffer is greater than zero, the electronic device recognizes that there is an object to be deleted. Accordingly, the electronic device returns to step 413 and identifies whether a tap of an object not stored in the temporary buffer is sensed.

Referring back to step 417, when the deletion event has occurred in step 417, the electronic device proceeds to step 425 and deletes the objects stored in the temporary buffer. For instance, when a user drags the touched OBJ 5 and OBJ 6 to the deletion area as illustrated in FIG. 2C, the electronic device deletes OBJ 5 and OBJ 6 as illustrated in FIG. 2D.

Next, the electronic device terminates the method of the present invention.

In the aforementioned exemplary embodiment, after activating an object deletion mode, an electronic device changes a stored list of objects to be deleted.

In another exemplary embodiment, even before activating an object deletion mode, an electronic device may change a list of objects to be deleted. In this case, a touch sustenance time for determining object deletion mode activation in the electronic device represents a touch sustenance time starting from a touch time sensed in step 401. For example, when OBJ 5 and OBJ 6 illustrated in FIG. 2B are multi-touched in step 401, although the touch of any one of OBJ 5 and OBJ 6 is released, the electronic device identifies whether to activate an object deletion mode using the touch sustenance time starting from the touch time sensed in step 401. For another example, when OBJ 6 is additionally touched after OBJ 5 illustrated in FIG. 2B is touched in step 401, although the touch of OBJ 5 is released, the electronic device may identify if an object deletion mode is activated using the touch sustenance time starting from the touch time sensed in step 401.

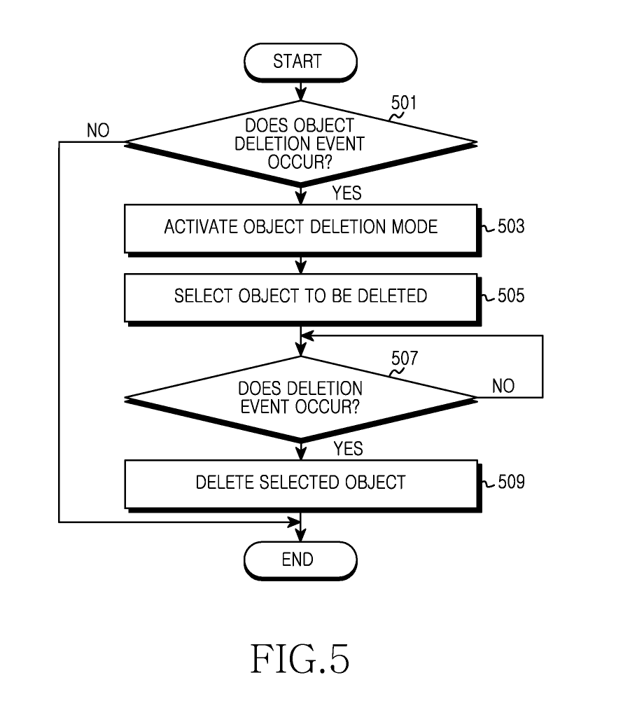

FIG. 5 illustrates a procedure for selecting an object to be deleted using touch information in the electronic device according to a third exemplary embodiment of the present invention.

Referring to FIG. 5, in step 501, the electronic device identifies if an object deletion event has occurred. For example, when a touch sustenance time for an object is longer than a reference time, the electronic device recognizes that the object deletion event has occurred. In another example, the electronic device can identify if an object deletion icon is selected. In a further example, when a touch sustenance time for an area on the screen where an object is not located is longer than the reference time, the electronic device may recognize that the object deletion event has occurred.

If it is identified in step 501 that the object deletion event has not occurred, the electronic device terminates the method of the present invention. On the other hand, when it is identified in step 501 that the object deletion event has occurred, the electronic device proceeds to step 503 and activates an object deletion mode. For example, when the object deletion mode is activated, the electronic device displays the objects on the screen such that the objects are vibrated at regular or irregular intervals. In another example, when the object deletion mode is activated, the electronic device may display a background shade of the screen darker than before activating the object deletion mode. In a further example, when the object deletion mode is activated, the electronic device may display a pop-up window including object deletion mode activation information.

After activating the object deletion mode, the electronic device proceeds to step 505 and selects an object to be deleted. For example, the electronic device stores an object, which is tapped by a user, in a temporary buffer. In the exemplary embodiment, the electronic device selects and marks the object stored in the temporary buffer such that the object stored in the temporary buffer is distinguished from an object not stored in the temporary buffer. If a tap of the selected and marked object is sensed, the electronic device releases the selection and marking of the tapped object. That is, the electronic device deletes the tapped object from the temporary buffer.

Next, the electronic device proceeds to step 507 and identifies whether a deletion event has occurred. For example, the electronic device identifies if a drag of an object to a deletion area is sensed.

If it is identified in step 507 that no deletion event has occurred, the method loops back to repeat step 507 until a deletion event has occurred. However, if it is identified in step 507 that the deletion event has occurred, the electronic device proceeds to step 509 and deletes the objects selected in step 505 and shown in FIG. 2B. For example, when OBJ 5 and OBJ 6 selected for deletion are dragged to the deletion area as illustrated in FIG. 2C, the electronic device deletes OBJ 5 and OBJ 6 from the screen as illustrated in FIG. 2D.

After that, the electronic device terminates the method of the present invention.

In the aforementioned exemplary embodiment, an electronic device selects an object to be deleted using tap information.

In another exemplary embodiment, an electronic device may set a deletion area and select an object to be deleted.

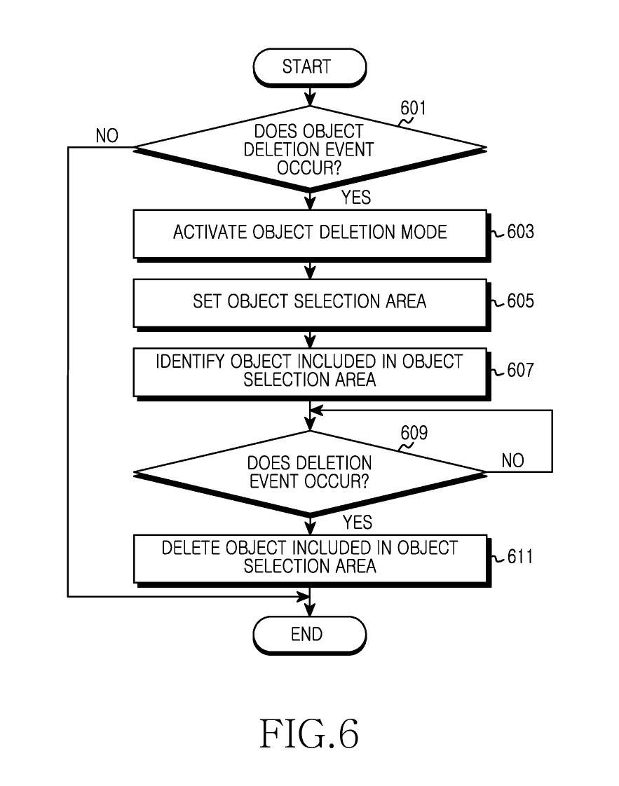

FIG. 6 illustrates a procedure for selecting an object to be deleted using touch information in the electronic device according to a fourth exemplary embodiment of the present invention.

Referring to FIG. 6, in step 601, the electronic device identifies if an object deletion event has occurred. For example, when a touch sustenance time for an object is longer than a reference time, the electronic device recognizes that the object deletion event has occurred. In another example, the electronic device can identify if an object deletion icon is selected. In a further example, when a touch sustenance time for an area where an object is not located in a screen is longer than the reference time, the electronic device may recognize that the object deletion event has occurred.

If it is identified in step 601 that the object deletion event has not occurred, the electronic device terminates the method of the present invention. On the other hand, when it is identified in step 601 that the object deletion event has occurred, the electronic device proceeds to step 603 and activates an object deletion mode. For example, when the object deletion mode is activated, the electronic device displays the objects on the screen such that the objects are vibrated at regular or irregular intervals. In another example, when the object deletion mode is activated, the electronic device may display a background shade of the screen darker than before activating the object deletion mode. In a further example, when the object deletion mode is activated, the electronic device may display a pop-up window including object deletion mode activation information.

After activating the object deletion mode, the electronic device proceeds to step 605 and sets an object selection area. For example, the electronic device identifies the object selection area through drag information by a user. In another example, the electronic device may set the object selection area using tap points inputted on the screen by the user.

Next, the electronic device proceeds to step 607 and identifies an object included in the object selection area. In the exemplary embodiment, the electronic device selects and marks the object included in the object selection area such that the object included in the object selection area is distinguished from objects not included in the object selection area.

Next, the electronic device proceeds to step 609 and identifies if a deletion event has occurred. For example, the electronic device identifies if a drag of an object to a deletion area is sensed.

If it is identified in step 609 that no deletion event has occurred, the method loops back to repeat step 609 until a deletion event has occurred. However, if it is identified in step 609 that the deletion event has not occurred, the electronic device proceeds to step 611 and deletes the objects included in the object selection area. For example, in a case where OBJ 5 and OBJ 6 are included in the object selection area identified by a multi-touch, as shown in FIG. 2B, and the portion of the screen including both OBJ 5 and OBJ 6 is dragged to the deletion area, as shown in FIG. 2C, the electronic device deletes OBJ 5 and OBJ 6 included in the object selection area as illustrated in FIG. 2D.

Next, the electronic device terminates the method of the present invention.

In the aforementioned exemplary embodiment, an electronic device sets tap information for each object as illustrated in FIG. 5 or sets an object selection area as illustrated in FIG. 6 and selects an object to be deleted.

In another exemplary embodiment of the present invention, an electronic device may merge the features of FIG. 5 and FIG. 6 and select an object to be deleted.

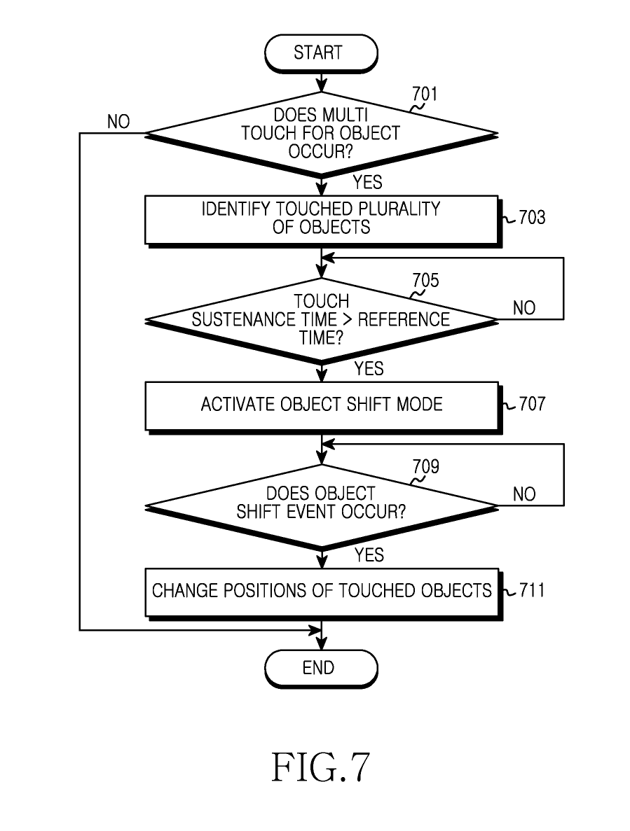

In the aforementioned exemplary embodiment, an electronic device selects a plurality of objects and, by one event occurrence, deletes the selected plurality of objects. In an alternative exemplary embodiment, the electronic device may change positions of the plurality of objects by one event occurrence using similar methods as illustrated in FIG. 7 to FIG. 14F and described below.

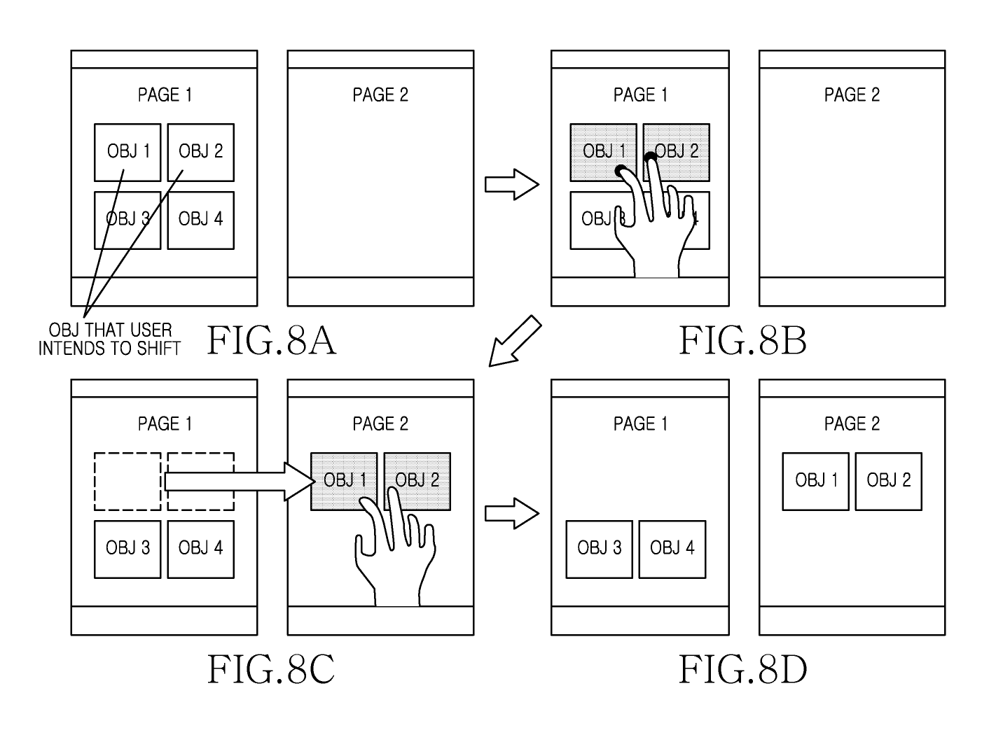

FIGS. 7 and 8A-8D illustrate a procedure for shifting an object using a multi-touch in the electronic device according to the alternative exemplary embodiment of the present invention.

Referring to FIGS. 7 and 8A-8D, the electronic device proceeds to step 701 and identifies if a multi-touch of objects is sensed or detected to have occurred. For example, when a user wants to change positions of OBJ 1 and OBJ 2 illustrated in FIG. 8A, the electronic device can detect a multi-touch of OBJ 1 and OBJ 2 by the user as illustrated in FIG. 8B. Accordingly, the electronic device identifies if a multi-touch of OBJ 1 and OBJ 2 is sensed in step 701 as illustrated in FIG. 8B.

If it is identified in step 701 that the multi-touch of the objects is not sensed, the electronic device recognizes that a shift event for the objects has not occurred. Therefore, the electronic device terminates the method of the present invention.

However, when it is identified in step 701 that the multi-touch of the objects is sensed, the electronic device proceeds to step 703 and identifies the multi-touched plurality of objects.

After that, the electronic device proceeds to step 705 and identifies if a sustenance time of the multi-touch sensed in step 701 is longer than a reference time.

If it is identified in step 705 that the sustenance time of the multi-touch is shorter than or is equal to the reference time, the electronic device recognizes that the shift event for the objects has not occurred. If the multi-touch sensed in step 701 is released, the electronic device loops back and proceeds to step 705 and again identifies if a sustenance time of the multi-touch sensed in step 701 is longer than the reference time. Alternatively, in step 705, when the multi-touch sensed in step 701 is released, the electronic device terminates the method of the present invention.

On the other hand, when it is identified in step 705 that the touch sustenance time of the multi-touch is longer than the reference time, the electronic device proceeds to step 707 and activates an object shift mode. For example, when activating the object shift mode, the electronic device displays the objects on a screen such that the objects appear to vibrate at regular or irregular intervals. In another example, when activating the object shift mode, the electronic device may display a background shade of the screen darker than before activating the object shift mode. In a further example, when activating the object shift mode, the electronic device may display a pop-up window including object shift mode activation information.

Next, the electronic device proceeds to step 709 and identifies if a position change event has occurred. For example, the electronic device identifies if the objects multi-touched in step 701 are dragged to a second page as illustrated in FIG. 8C. In an illustrative example shown in FIGS. 8A-8D, the objects OBJ 1 to OBJ 4 are displayed on a first page of the screen, and the deletion area may be a separate second page shown on the screen adjacent to the first page.

If it is identified in step 709 that no shift event has occurred, the method loops back to repeat step 709 to detect a shift event. However, if it is identified in step 709 that the shift event has occurred, the electronic device proceeds to step 711 and changes positions of the plurality of objects selected through the multi-touch. For example, when multi-touched OBJ 1 and OBJ 2 are dragged to the second page as illustrated in FIG. 8C, the electronic device changes positions of OBJ 1 and OBJ 2 to the second page as illustrated in FIG. 8D.

After step 711, the electronic device terminates the method of the present invention.

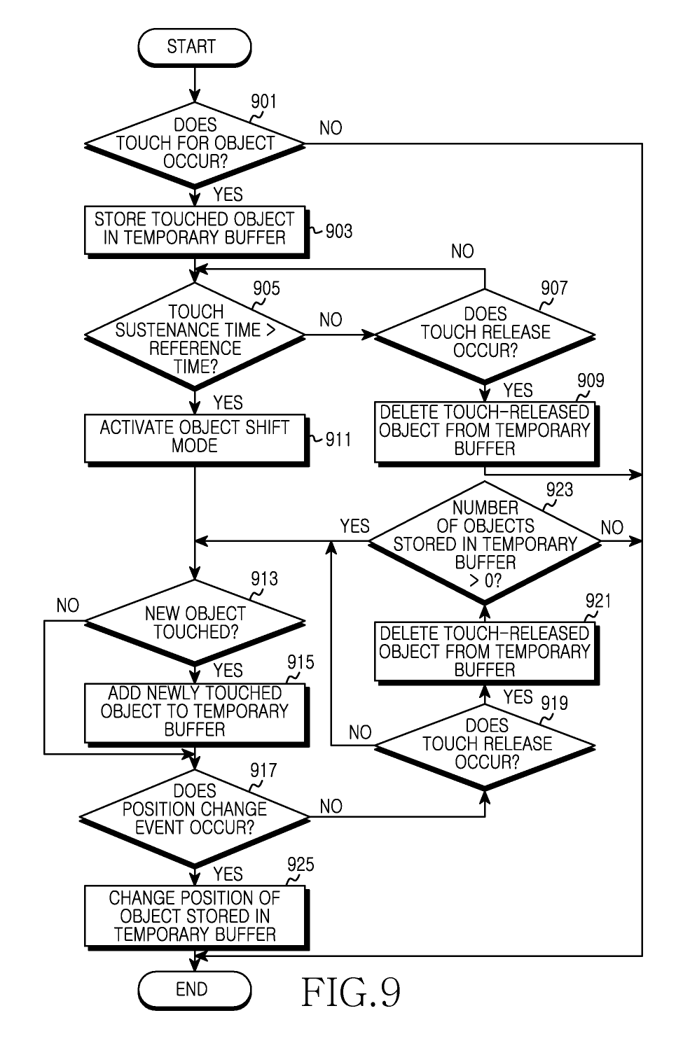

As described above, the electronic device operating in accordance with the present invention changes positions of a plurality of objects selected through a multi-touch, by a single shift event. In the exemplary embodiment, after activating an object shift mode, the electronic device may additionally select an object to change a position as illustrated in FIG. 9 and described below.

FIG. 9 illustrates a procedure for selecting an object to be shifted using touch information in an electronic device according to the first exemplary embodiment of the present invention.

Referring to FIG. 9, in step 901, the electronic device identifies if a touch of an object is sensed.

If it is identified in step 901 that the touch of the object is not sensed, the electronic device recognizes that a shift event for the object has not occurred. Therefore, the electronic device terminates the method of the present invention.

On the other hand, when it is identified in step 901 that the touch of the object is sensed, the electronic device proceeds to step 903 and stores the touched object in a temporary buffer. Here, the temporary buffer includes at least one object selected to change a position.

After that, the electronic device proceeds to step 905 and identifies if a sustenance time of the touch sensed in step 901 is longer than a reference time.

When it is identified in step 905 that the sustenance time of the touch is shorter than or is equal to the reference time, the electronic device proceeds to step 907 and identifies if the touch of the object sensed in step 901 is released.

If it is identified in step 907 that the touch of the object is not released, the electronic device returns to step 905 and again identifies if a sustenance time of the touch sensed in step 901 is longer than the reference time.

However, when it is identified in step 907 that the touch of the object is released, the electronic device recognizes that the shift event for the object has not occurred. Accordingly, the electronic device proceeds to step 909 and deletes object information stored in the temporary buffer. After that, the electronic device terminates the method of the present invention.

Referring back to step 905, when it is identified in step 905 that the sustenance time of the touch is longer than the reference time, the electronic device proceeds to step 911 and activates an object shift mode. For example, when activating the object shift mode, the electronic device displays objects on a screen such that the objects are vibrated at regular or irregular intervals. In another example, when activating the object shift mode, the electronic device may display a background shade of the screen darker before activating the object shift mode. In a further example, when activating the object shift mode, the electronic device may display a pop-up window including object shift mode activation information. In the exemplary embodiment, the electronic device selects and marks the object included in the temporary buffer such that the object included in the temporary buffer is distinguished from other objects not included in the temporary buffer.

Next, the electronic device proceeds to step 913 and identifies if a touch of a new object is sensed.

When it is identified in step 913 that the touch of the new object is not sensed, the electronic device jumps to step 917 and identifies if a position change event has occurred. For example, the electronic device identifies if at least one touched object is dragged to another area on the screen, such as from a first page to a second page as shown in FIGS. 8A-8D.

On the other hand, referring back to step 913, when it is identified in step 913 that the touch of the new object is sensed, the electronic device proceeds to step 915 and adds the newly touched object to the temporary buffer.

Next, the electronic device proceeds to step 917 and identifies if the position change event has occurred. For example, the electronic device identifies if at least one touched object is dragged to the other area or page.

If it is identified in step 917 that the position change event has not occurred, the electronic device proceeds to step 919 and identifies if a touch release for the object is sensed.

If it is identified in step 919 that no touch release of an object has occurred, the electronic device returns to step 913 and again identifies if a touch of a new object is sensed.

However, if it is identified in step 919 that a touch release of an object has occurred, the electronic device proceeds to step 921 and deletes the touch-released object from the temporary buffer.

Next, the electronic device proceeds to step 923 and identifies if the number of objects stored in the temporary buffer is greater than zero.

If it is identified in step 923 that the number of objects stored in the temporary buffer is equal to zero, the electronic device recognizes that there is no object to change a position. Therefore, the electronic device terminates the method of the present invention.

However, when it is identified in step 923 that the number of objects stored in the temporary buffer is greater than zero, the electronic device recognizes that there is an object to change a position. Accordingly, the electronic device returns to step 913 and again identifies whether a touch of a new object is sensed.

Referring back to step 917, when the position change event has occurred in step 917, the electronic device proceeds to step 925 and changes positions of the objects stored in the temporary buffer. For example, when the touched objects OBJ 1 and OBJ 2 are dragged to the second page as illustrated in FIG. 8C, the electronic device changes positions of OBJ 1 and OBJ 2 to the second page as illustrated in FIG. 8D.

Next, the electronic device terminates the method of the present invention.

As described above, an electronic device changes positions of touched objects. In the exemplary embodiment, the electronic device can set a shift position to different locations on the screen depending on a touch release time of each object. For example, when a touch release for OBJ 1 is sensed after OBJ 1 and OBJ 2 are dragged to the second page in FIG. 8D, the electronic device changes a position of OBJ 1 to the second page. After that, if OBJ 2 is touch released after being dragged elsewhere on the second page or to a third page, or additional pages, the electronic device changes a position of OBJ 2 to the other locations on the second, third, or additional pages.

In the aforementioned exemplary embodiment, after activating an object shift mode, an electronic device changes a stored list of objects for reflecting the changed positions, for example, by updating such a stored list to indicate where OBJ 1 and OBJ 2 have been shifted or relocated.

In another exemplary embodiment, even before activating an object shift mode, an electronic device can change a list of objects having changed positions. In this case, a touch sustenance time for determining object shift mode activation in the electronic device represents a touch sustenance time starting from a touch time sensed in step 901. For example, when OBJ 1 and OBJ 2 are multi-touched in step 901, although the touch of any one of OBJ 1 and OBJ 2 is released, the electronic device identifies if an object shift mode is activated using a touch sustenance time starting from the touch time sensed in step 901. For another example, when OBJ 2 is additionally touched by the user after OBJ 1 is touched in step 901, although the touch of OBJ 1 is released, the electronic device may identify if an object shift mode is activated using the touch sustenance time starting from the touch time sensed in step 901.

In the aforementioned exemplary embodiment, an electronic device recognizes objects whose touches are held by a user of the electronic device, as objects for changing or shifting positions on the screen.

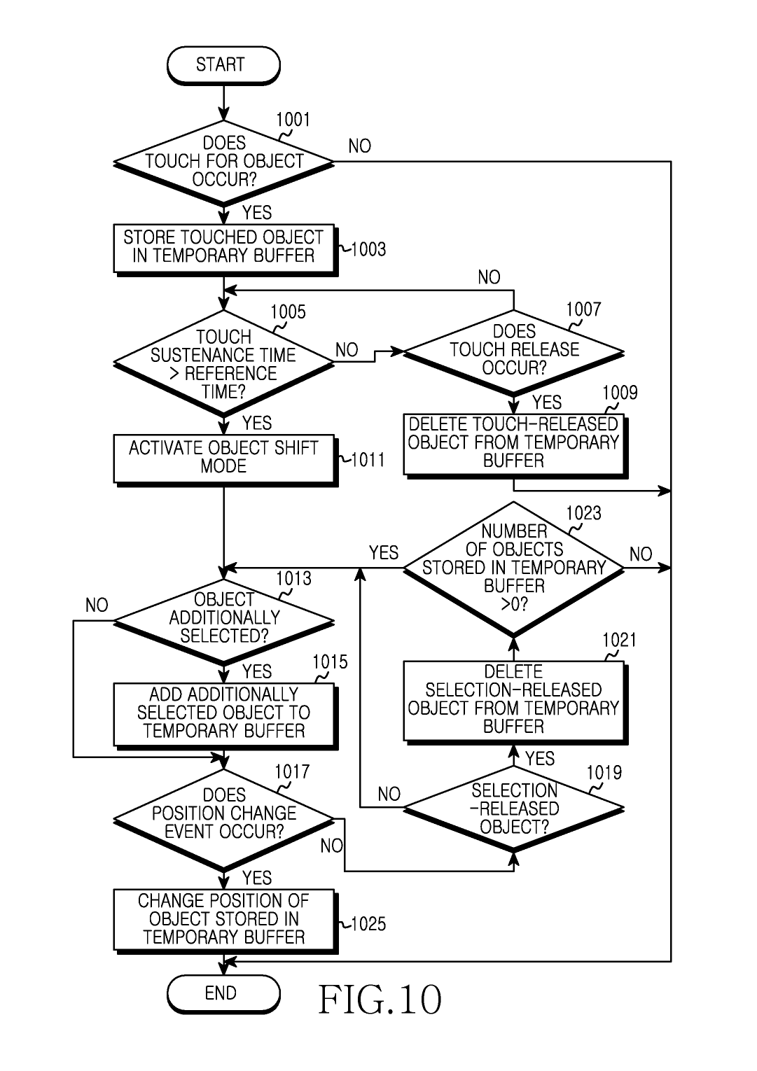

In another exemplary embodiment, when an object shift mode is activated, an electronic device may select an object for changing a position using tap information as illustrated in FIG. 10 below.

FIG. 10 illustrates a procedure for selecting an object to be shifted using touch information in an electronic device according to a second exemplary embodiment of the present invention.

Referring to FIG. 10, in step 1001, the electronic device identifies if a touch of an object is sensed.

If it is identified in step 1001 that the touch of the object is not sensed, the electronic device recognizes that a shift event for the object has not occurred. Therefore, the electronic device terminates the method of the present invention.

On the other hand, when it is identified in step 1001 that the touch of the object is sensed, the electronic device proceeds to step 1003 and stores the touched object in a temporary buffer. Here, the temporary buffer includes an object selected to change a position.

After that, the electronic device proceeds to step 1005 and identifies if a sustenance time of the touch sensed in step 1001 is longer than a reference time.

If it is identified in step 1005 that the sustenance time of the touch is shorter than or is equal to the reference time, the electronic device proceeds to step 1007 and identifies if the touch of the object touched in step 1001 is released.

If it is identified in step 1007 that the touch of the object is not released, the electronic device returns to step 1005 and again identifies if a sustenance time of the touch sensed in step 1001 is longer than the reference time.

However, when it is identified in step 1007 that the touch of the object is released, the electronic device recognizes that the shift event for the object has not occurred. Accordingly, the electronic device proceeds to step 1009 and deletes object information stored in the temporary buffer. After that, the electronic device terminates the method of the present invention.

Referring back to step 1005, if it is identified in step 1005 that the sustenance time of the touch is longer than the reference time, the electronic device proceeds to step 1011 and activates an object shift mode. For example, when activating the object shift mode, the electronic device displays objects on a screen such that they are vibrated at regular or irregular intervals. In another example, when activating the object shift mode, the electronic device may display a background shade of the screen darker before activating the object shift mode. In a further example, when activating the object shift mode, the electronic device may display a pop-up window including object shift mode activation information. In the exemplary embodiment, the electronic device selects and marks the object included in the temporary buffer such that the object included in the temporary buffer is distinguished from other objects not included in the temporary buffer.

Next, the electronic device proceeds to step 1013 and identifies if a tap of an object not stored in the temporary buffer is sensed. That is, the electronic device identifies if a tap of an object not selected as an object for changing a position is sensed.

When it is identified in step 1013 that the tap of the object not stored in the temporary buffer is not sensed, the electronic device jumps to step 1017 and identifies if a position change event has occurred. For example, the electronic device identifies if a drag to another area or page on the screen is sensed.

On the other hand, referring back to step 1013, when it is identified in step 1013 that the tap of the object not stored in the temporary buffer is sensed, the electronic device proceeds to step 1015 and adds the newly tapped object to the temporary buffer.

Next, the electronic device proceeds to step 1017 and identifies if the position change event has occurred. For example, the electronic device identifies if a drag to the other area or page is sensed.

If it is identified in step 1017 that the position change event has not occurred, the electronic device proceeds to step 1019 and identifies if a selection-released object exists. For example, the electronic device identifies if a tap of the object stored in the temporary buffer is sensed.

When it is identified in step 1019 that no tap of the object stored in the temporary buffer has been sensed, the electronic device recognizes that there is no selection-released object. In this case, the electronic device returns to step 1013 and again identifies if a tap of the object not stored in the temporary buffer is sensed.

However, when it is identified in step 1019 that the tap of the object stored in the temporary buffer is sensed, the electronic device recognizes that there is a selection-released object. In this case, the electronic device proceeds to step 1021 and deletes the touch-released object from the temporary buffer.

Next, the electronic device proceeds to step 1023 and identifies if the number of objects stored in the temporary buffer is greater than zero.

If it is identified in step 1023 that the number of objects stored in the temporary buffer is equal to zero, the electronic device recognizes that there is no object to change a position. Therefore, the electronic device terminates the method of the present invention.

However, if it is identified in step 1023 that the number of objects stored in the temporary buffer is greater than zero, the electronic device recognizes that there is an object to change a position. Accordingly, the electronic device returns to step 1013 and again identifies whether a tap of an object not stored in the temporary buffer is sensed.

Referring back to step 1017, when the position change event has occurred in step 1017, the electronic device proceeds to step 1025 and changes positions of the objects stored in the temporary buffer. For example, when selected objects OBJ 1 and OBJ 2 are dragged to the second page as illustrated in FIG. 8C, the electronic device changes positions of OBJ 1 and OBJ 2 to the second page as illustrated in FIG. 8D.

Next, the electronic device terminates the method of the present invention.

In the aforementioned exemplary embodiment, after activating an object shift mode, an electronic device changes a stored list of objects to change positions.

In another exemplary embodiment, even before activating an object shift mode, an electronic device may change a list of objects for changing positions. In this case, a touch sustenance time for determining object shift mode activation in the electronic device represents a touch sustenance time starting from a touch time sensed in step 1001. For example, when OBJ 1 and OBJ 2 are multi-touched in step 1001, although the touch of any one of OBJ 1 and OBJ 2 is released, the electronic device identifies whether an object shift mode is activated using the touch sustenance time starting from the touch time sensed in step 1001. For another example, when OBJ 2 is additionally touched after OBJ 1 is touched in step 1001, although the touch of OBJ 1 is released, the electronic device may identify if an object shift mode is activated using the touch sustenance time starting from the touch time sensed in step 1001.

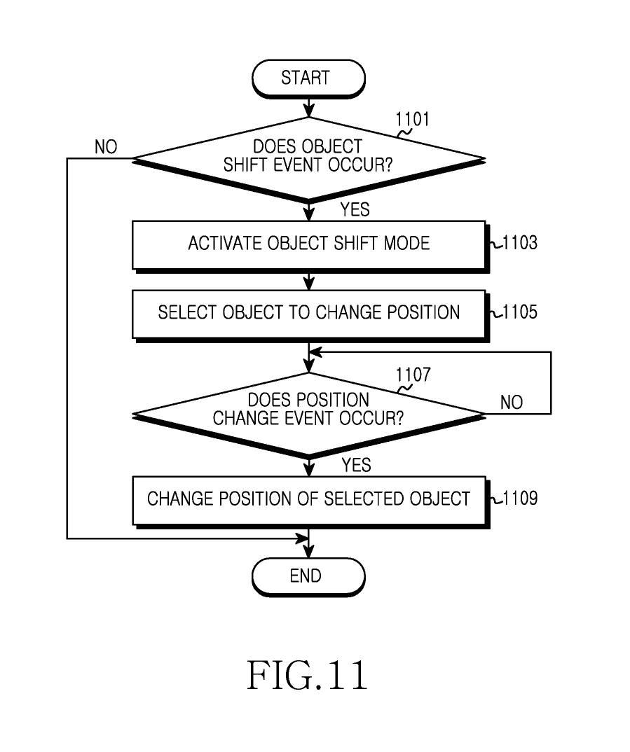

FIG. 11 illustrates a procedure for selecting an object to be shifted using touch information in an electronic device according to a third exemplary embodiment of the present invention.

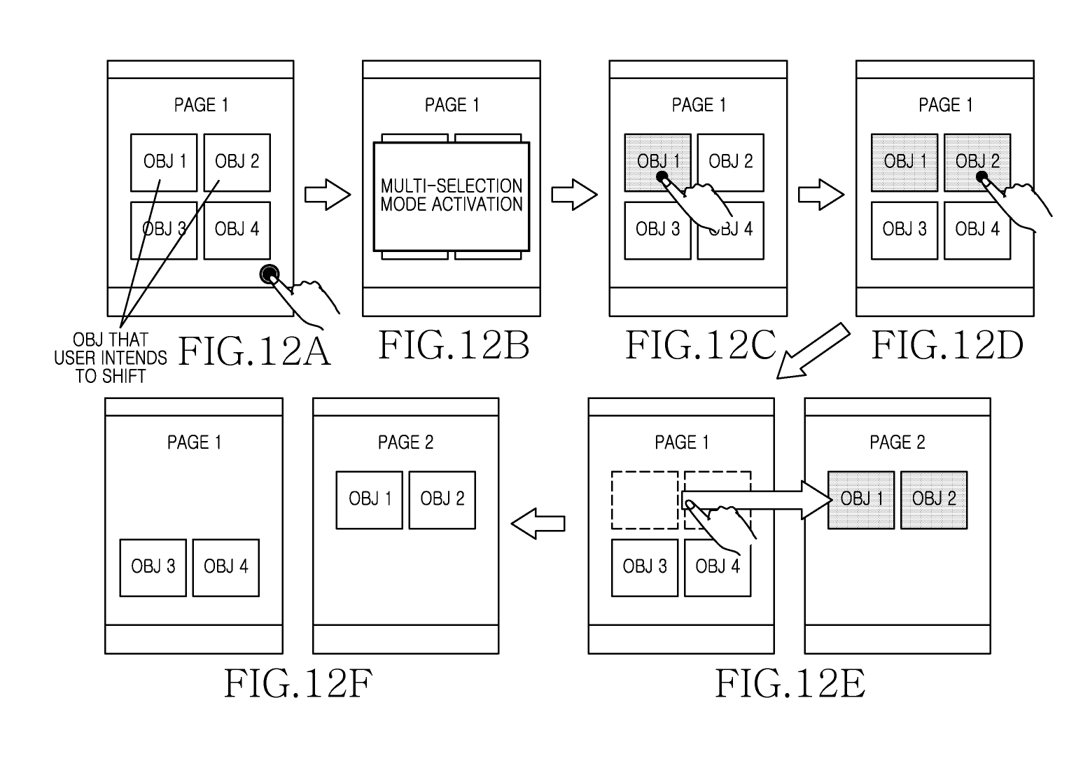

Referring to FIG. 11, in step 1101, the electronic device identifies if an object shift event has occurred. For example, when a touch sustenance time for an object is longer than a reference time, the electronic device recognizes that the object shift event has occurred. In another example, the electronic device can identify if an object shift icon is selected. In a further example, when a touch sustenance time in an area on the screen where an object is not located, such as a predetermined area as illustrated in FIG. 12A, is longer than the reference time, the electronic device may recognize that the object shift event has occurred.

If it is identified in step 1101 that an object shift event has not occurred, the electronic device terminates the method of the present invention. On the other hand, when it is determined in step 1101 that an object shift event has occurred, the electronic device proceeds to step 1103 and activates an object shift mode. For example, when activating the object shift mode, the electronic device displays the objects on the screen such that the objects are vibrated at regular or irregular intervals. In another example, when activating the object shift mode, the electronic device may display a background shade of the screen darker than before activating the object shift mode. In a further example, when activating the object shift mode, the electronic device can display an object selection pop-up window resulting from the object shift mode activation as illustrated in FIG. 12B.

After activating the object shift mode, the electronic device proceeds to step 1105 and selects an object to change a position. For example, the electronic device stores, in a temporary buffer, objects OBJ 1 and OBJ 2 for which respective taps are sensed as illustrated in FIGS. 12C and 12D. In the exemplary embodiment, the electronic device selects and marks each object selected for a position change such that each selected object is distinguished from non-selected objects. If a tap of the object stored in the temporary buffer is sensed, the electronic device releases the selection and marking for the tapped object. That is, if a tap of the selected and marked object is sensed, the electronic device deletes the tapped object from the temporary buffer.

Next, the electronic device proceeds to step 1107 and identifies whether a shift event has occurred. For example, the electronic device identifies if at least one object, or alternatively a portion of the screen containing such at least one object, is dragged by a user as illustrated in FIG. 12E.

If it is identified in step 1107 that no shift event has occurred, the method loops back to repeat step 1107 until a deletion event has occurred. However, if it is identified in step 1107 that the shift event has occurred, the electronic device proceeds to step 1109 and changes positions of the objects selected in step 1105. For example, when OBJ 1 and OBJ 2 selected for position change are dragged to the second page as illustrated in FIG. 12E, the electronic device changes positions of OBJ 1 and OBJ 2 from the first page to the second page as illustrated in FIG. 12F.

After that, the electronic device terminates the method of the present invention.

In the aforementioned exemplary embodiment, an electronic device selects an object for changing a position using tap information.

In another exemplary embodiment, an electronic device may set a shift area and select an object for changing a position.

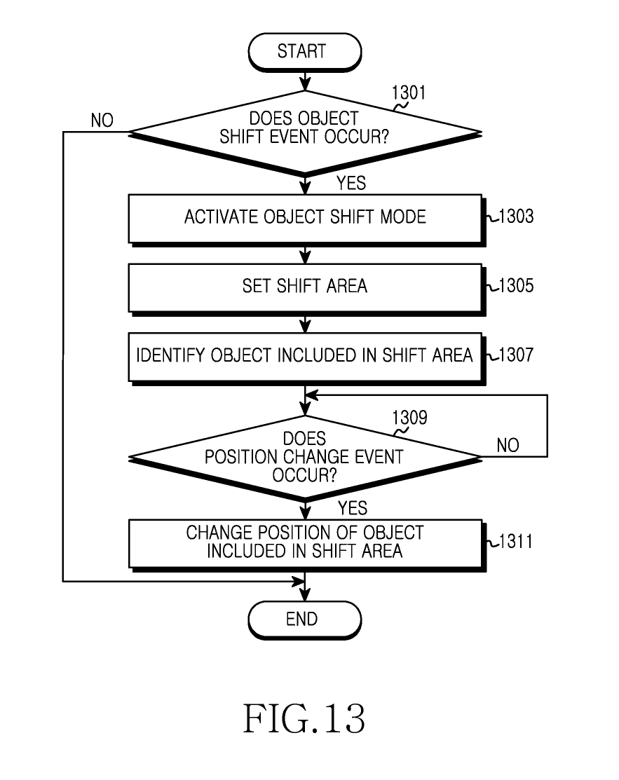

FIG. 13 illustrates a procedure for selecting an object to be shifted using touch information in an electronic device according to a fourth exemplary embodiment of the present invention.

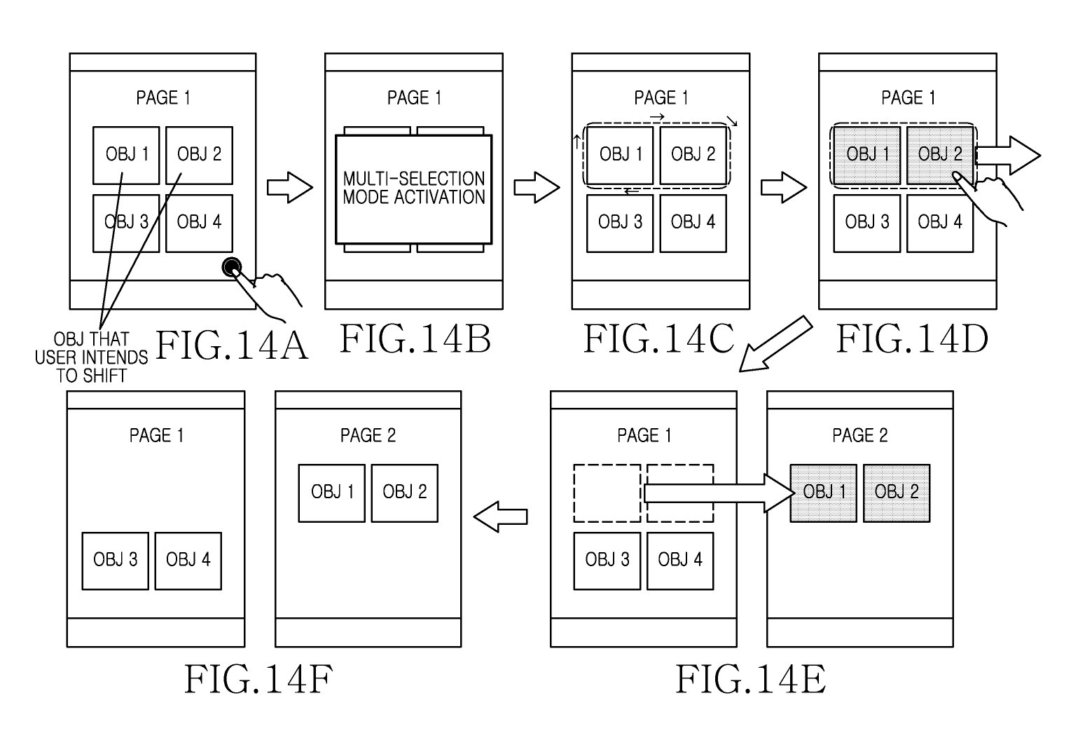

Referring to FIG. 13, in step 1301, the electronic device identifies if an object shift event has occurred. For example, when a touch sustenance time for an object is longer than a reference time, the electronic device recognizes that the object shift event has occurred. In another example, the electronic device can identify if an object shift icon is selected. In a further example, when a touch sustenance time in an area on the screen where an object is not located, such as a predetermined area as illustrated in FIG. 14A, is longer than the reference time, the electronic device may recognize that an object shift event has occurred.

If it is identified in step 1301 that an object shift event has not occurred, the electronic device terminates the method of the present invention. On the other hand, when it is determined in step 1301 that an object shift has occurred, the electronic device proceeds to step 1303 and activates an object shift mode. For example, when activating the object shift mode, the electronic device displays the objects on the screen such that the objects are vibrated at regular or irregular intervals. In another example, when activating the object shift mode, the electronic device may display a background shade of the screen darker than before activating the object shift mode. In a further example, when activating the object shift mode, the electronic device can display an object selection pop-up window resulting from the object shift mode activation as illustrated in FIG. 14B.

After activating the object shift mode, the electronic device proceeds to step 1305 and sets a shift area. For example, the electronic device determines the shift area using drag information by a user as illustrated in FIG. 14C, represented by dashed lines or other graphical indicia delineating the shift area. In another example, the electronic device may set the shift area using tap points by the user, with the tap points, for example, defining opposing vertices of a rectangular area as the shift area.

Next, the electronic device proceeds to step 1307 and identifies an object included in the shift area. For example, the electronic device identifies OBJ 1 and OBJ 2 as being included in the shift area as illustrated in FIG. 14D. In the exemplary embodiment, the electronic device selects and marks the object included in the shift area such that the object included in the shift area is distinguished from objects not included in the shift area. For example, as shown in FIG. 14D, the shift area may have the objects therein distinguished by having different coloring of the included objects from the coloring of the objects outside of the shift area.

Next, the electronic device proceeds to step 1309 and identifies whether a shift event has occurred. For example, the electronic device identifies if a drag of the shift area on the screen is sensed as illustrated in FIG. 14E.

If it is identified in step 1309 that no shift event has occurred, the method loops back to repeat step 1309 until a shift event has occurred. However, if it is identified in step 1309 that the shift event has occurred, the electronic device proceeds to step 1311 and changes positions of the objects included in the shift area. For example, when the shift area on the screen is dragged to the second page as illustrated in FIG. 14E, the electronic device changes positions of OBJ 1 and OBJ 2 included in the shift area to the second page as illustrated in FIG. 14F.

After that, the electronic device terminates the method of the present invention.

In the aforementioned exemplary embodiment, an electronic device sets tap information for an object as illustrated in FIG. 11 or sets a shift area as illustrated in FIG. 13 and selects at least one object to change a position.

In another exemplary embodiment, an electronic device may merge the features of FIG. 11 and FIG. 13 and select an object to change a position.

An example construction or implementation of an electronic device for deleting or shifting a plurality of objects by one event occurrence is described below.

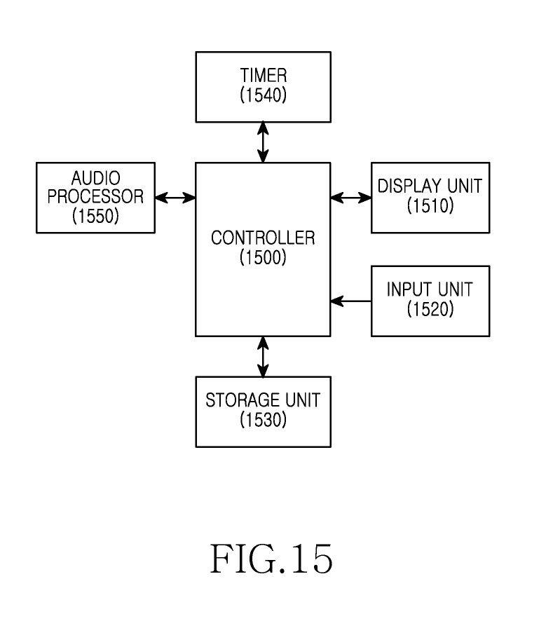

FIG. 15 illustrates a construction of an electronic device according to the present invention.

As illustrated, the electronic device includes a controller 1500, a display unit 1510, an input unit 1520, a storage unit 1530, and an audio processor 1550.

The controller 1500 performs the whole operation control of the electronic device.

The controller 1500 edits a plurality of objects in response to a single event occurrence. For example, the controller 1500 deletes at least one object by one deletion event occurrence as illustrated in FIG. 1 to FIG. 6. In the exemplary embodiment, the controller 1500 responds to a selection of at least one object to be deleted using touch information about the object, tap information and deletion area setting information received from the input unit 1520 and/or the display unit 1510 which may include a touch screen. In another example, the controller 1500 changes a position of at least one object on a screen in response to a single shift event occurrence as illustrated in FIG. 7 to FIG. 14F. In the exemplary embodiment, the controller 1500 responds to a selection of at least one object to change a position on a screen using the touch information about the object, the tap information and the deletion area setting information.

The display unit 1510 displays status information of the electronic device, a character input by a user, a moving picture or image, a still picture or image, and the like according to the control of the controller 1500. If the display unit 1510 is constructed to include or be mounted to a touch screen, the display unit 1510 provides input data, entered through the touch screen, to the controller 1500. For example, the display unit 1510 displays an object as illustrated in FIGS. 2A-2D, FIGS. 8A-8D, FIGS. 12A-12F, and FIGS. 14A-14F.

The input unit 1520 provides input data generated by a user's selection or entry to the controller 1500. For example, the input unit 1520 may be constructed to include only a control button for control of the electronic device. In another example, the input unit 1520 may be constructed as a keypad for receiving input data from a user.

The storage unit 1530 can be composed of a program storage unit for storing a program for controlling an operation of the electronic device, and a data storage unit for storing data generated during program execution. For example, the storage unit 1530 stores the various buffers and stored lists described herein.

The audio processor 1550 controls input/output of an audio signal. For example, the audio processor 1550 externally transmits an audio signal provided from the controller 1500 through a speaker, and provides an audio signal input from a microphone to the controller 1500.

In the aforementioned exemplary embodiments of the present invention, the controller 1500 of the electronic device activates an object deletion mode or an object shift mode using a touch sustenance time on an object or a touch sustenance time on a screen. Accordingly, the electronic device may further include a timer 1540 for identifying the touch sustenance time.

Also, the electronic device may further include a communication unit for processing a signal transmitted/received through an antenna and/or over a communications interface to other devices and networks.

The above-described apparatus and methods according to the present invention can be implemented in hardware or firmware, or as software or computer code, or combinations thereof. In addition, the software or computer code can also be stored in a non-transitory recording medium such as a CD ROM, a RAM, a ROM whether erasable or rewritable or not, a floppy disk, CDs, DVDs, memory chips, a hard disk, a magnetic storage media, an optical recording media, or a magneto-optical disk or computer code downloaded over a network originally stored on a remote recording medium, a computer readable recording medium, or a non-transitory machine readable medium and to be stored on a local recording medium, so that the methods described herein can be rendered in such software, computer code, software modules, software objects, instructions, applications, applets, apps, etc. that is stored on the recording medium using a general purpose computer, a digital computer, or a special processor or in programmable or dedicated hardware, such as an ASIC or FPGA. As would be understood in the art, the computer, the processor, microprocessor controller or the programmable hardware include volatile and/or non-volatile storage and memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, the program may be electronically transferred through any medium such as communication signals transmitted by wire/wireless connections, and their equivalents. The programs and computer readable recording medium can also be distributed in network-coupled computer systems so that the computer readable code is stored and executed in a distributed fashion.

As described above, exemplary embodiments of the present invention have an advantage of being capable of easily performing deletion of an object displayed on a display unit or performing a shift of a position of the object, by deleting a plurality of objects or changing positions of the plurality of in response to a single event occurrence in an electronic device including a touch screen.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for editing an object in an electronic device with a touch screen, the method comprising:
selecting a plurality of objects from displayed objects on the touch screen for editing using touch information; and
if an editing event occurs, performing editing of the selected objects.

2. The method of claim 1, wherein the selected objects comprises at least one of an icon, a widget, an item, a window, and an image.

3. The method of claim 1, wherein selecting the object comprises:
if a multi-touch is sensed for at least two objects of the displayed objects, identifying the multi-touched objects; and
if a sustenance time of the multi-touch is longer than a reference time, selecting the multi-touched objects.

4. The method of claim 3, further comprising:
after selecting the multi-touched objects, identifying if a touch of at least one object among objects not multi-touched is sensed; and
if the touch of the non-multi-touched object is sensed, additionally selecting the touched non-multi-touched object.

5. The method of claim 1, wherein selecting the objects comprises, if an object selection event occurs, selecting the objects using tap information.

6. The method of claim 5, wherein selecting the object further comprises, if a tap of the selected object is sensed, releasing the selection of the tapped object.

7. The method of claim 1, wherein selecting the objects comprises:
if an object selection event occurs, determining an editing area using touch information; and
selecting the objects located in the editing area.

8. The method of claim 1, wherein performing the editing of the selected objects comprises, if a position change event occurs, changing positions of the selected objects using drag information.

9. The method of claim 1, wherein performing the editing of the selected objects comprises, if a deletion event occurs, deleting the selected objects.

10. An electronic device comprising:
a touch screen displaying a plurality of objects; and
a controller for selecting a plurality of objects from the displayed objects for editing using touch information sensed through the touch screen and, if an editing event occurs, performing editing of the selected objects.

11. The electronic device of claim 10, wherein the selected objects comprises at least one of an icon, a widget, an item, a window, and an image.

12. The electronic device of claim 10, wherein, when a multi-touch is sensed for the objects of the displayed objects, if a sustenance time for the multi-touched objects is longer than a reference time, the controller selects the multi-touched objects.

13. The electronic device of claim 12, wherein, after selecting the multi-touched objects, if a touch of at least one object among objects not multi-touched is sensed, the controller additionally selects the touched non-multi-touched object.

14. The electronic device of claim 10, wherein, if an object selection event occurs, the controller selects the objects using tap information.

15. The electronic device of claim 14, wherein, if a tap of the selected objects is sensed, the controller releases the selection of the tapped object.

16. The electronic device of claim 10, wherein, if an object selection event occurs, the controller determines an editing area using touch information, and selects the objects located in the editing area.

17. The electronic device of claim 10, wherein, if a position change event occurs, the controller changes positions of the selected objects using drag information.

18. The electronic device of claim 10, wherein, if a deletion event occurs, the controller deletes the selected objects.
